(19) United States
(12) Patent Application Publication
(10) Pub. No.: US 2011/0229612 A1
(43) Pub. Date: Sep. 22, 2011

(54) SEAFOOD PREPARATION METHOD AND PRODUCT

(76) Inventors: Ming Bin Kou, Rolling Hills Estates, CA (US); Eddy Kai Kwong Lo, Torrance, CA (US); Wales Wei-Meng Yu, Walnut, CA (US)

(21) Appl. No.: 12/726,228

(22) Filed: Mar. 17, 2010

(51) Int. Cl. A22C 29/02; A23L 1/33

(52) U.S. Cl. 426/134; 452/6

(57) ABSTRACT

A food product comprises a lobster tail having a sternite, a shell portion generally covering dorsal and lateral sides of the lobster tail, and a meat portion disposed generally adjacent to the shell portion and the sternite. The sternite is split or cut along the length of the lobster tail thereby exposing the meat portion. A skewer extends through a proximate sternite portion and into the meat portion so that the skewer exits from the meat portion on or near the opposite meat lateral side at a location that is generally adjacent to a distal sternite portion. The skewer does not pierce or run through the shell portion at any location.

### FIELD OF THE INVENTION

This relates to a seafood preparation method and product. More specifically, this relates to lobster tail food products and their method of preparation.

### BACKGROUND

Lobster tails are popular seafood items today. They can be cooked by boiling or steaming them, frequently as part of the cooking of whole lobsters. Also a lobster tail can be separated from the rest of the lobster and cooked by frying, grilling or baking—often with the use of a skewer for assisting in the handling of the food while cooking.

FIG. 1A shows a conventional lobster tail food product 100 comprised of a lobster tail 102 and a skewer 104. The skewer 104 enters a meat portion 106 of the lobster tail 102, extends at a downward angle through the meat portion 106 and exits the lobster tail 102 through its hard shell portion 108. The relatively hard nature of the shell usually requires the use of a skewer that is constructed of metal so that the shell can be more easily pierced by the skewer without the use of other means for creating a hole in the shell.

FIG. 1B shows another conventional lobster tail food product 120 also comprised of a lobster tail 122 and a skewer 124. The skewer 124 extends through a meat portion 126 of the lobster tail 122 by running in a generally longitudinal direction through the length of the lobster tail 122. Depending upon whether or not it is desired to pierce the shell 128, this may also require that the skewer 124 be constructed of metal. Regardless of the skewer construction however, the generally longitudinal orientation of the skewer 124 can limit the number of lobster tails that can be placed upon one skewer. Moreover this orientation can sometimes affect the ease with which one or more lobster tails can be cooked when placed upon a grill or other cooking surface.

Thus there is a need for improved lobster tail food products and methods for preparing lobster tails for cooking and consumption.

### SUMMARY OF THE ILLUSTRATED EMBODIMENTS

Broadly speaking, certain embodiments of the invention relate to a food product comprising a lobster tail having a sternite, a shell portion generally covering dorsal and lateral sides of the lobster tail, and a meat portion disposed generally adjacent to the shell portion and the sternite. The sternite is split or cut along the length of the lobster tail thereby exposing the meat portion. A wood skewer extends through a proximate sternite portion and into the meat portion so that the skewer exits from the meat portion on or near the opposite meat lateral side at a location that is generally adjacent to a distal sternite portion. The skewer does not pierce or run through the shell portion at any location.

In one aspect, a lobster tail has a shell portion disposed generally on dorsal and lateral sides of the lobster tail, a sternite disposed generally on a ventral side of the lobster tail, and a meat portion disposed generally adjacent to the shell portion. The sternite is cut along an imaginary line generally running the length of the lobster tail thereby splitting at least a portion of the sternite and exposing the meat portion. After the cutting of the sternite, the sternite is comprised of a proximate sternite portion disposed on one side of the imaginary line and a distal sternite portion disposed on another side of the imaginary line. A skewer is pushed through the proximate sternite portion and into the meat portion, so that the skewer does not run through the shell portion.

In another aspect, at least a portion of the meat portion is pulled away from the shell portion after the cutting of the sternite and prior to the pushing of the skewer. That portion of the meat portion is then placed back onto the shell portion.

In another aspect, the skewer is pushed so that it exits from the meat portion at a location that is generally adjacent to the distal sternite portion without running through the shell portion.

In an alternative embodiment a lobster tail has a swimmeret, a shell portion disposed generally on dorsal and lateral sides of the lobster tail, and a meat portion disposed generally adjacent to the shell portion. The swimmeret is pulled in a direction generally away from the meat portion thereby at least partially separating the swimmeret from the lobster tail at a coxa joint and thereby exposing a membrane. A skewer is pushed through the membrane and into the meat portion, so that the skewer does not run through the shell portion

In another aspect a sternite is cut along an imaginary line generally running the length of the lobster tail thereby splitting at least a portion of the sternite and exposing the meat portion. After the cutting of the sternite, the sternite is comprised of a proximate sternite portion disposed on one side of the imaginary line and a distal sternite portion disposed on the other side of the imaginary line. The skewer is pushed so that it exits from the meat portion at a location that is generally adjacent to the distal sternite portion without running through the shell portion

In yet another embodiment, a food product comprises a lobster tail having a sternite, a shell portion disposed generally on dorsal and lateral sides of the lobster tail, and a meat portion disposed generally adjacent to the shell portion and the sternite. At least a portion of the sternite is split along an imaginary line generally running the length of the lobster tail thereby exposing the meat portion and thereby forming a proximate sternite portion disposed on one side of the imaginary line and a distal sternite portion disposed on the other side of the imaginary line. A skewer extends through the proximate sternite portion and into the meat portion. However the skewer does not run through the shell portion at any location.

In another aspect, at least a portion of the meat portion is not attached to the shell portion while disposed on the shell portion.

In another aspect, the skewer extends further through the meat portion so that the skewer exits from the meat portion at a location that is generally adjacent to the distal sternite portion without running through the shell portion.

In another aspect, the meat portion has a proximate meat lateral side and a distal meat lateral side. The skewer extends into the proximate meat lateral side and exits from the meat portion on the distal meat lateral side. The skewer further extends through the distal sternite portion. However the skewer does not extend through the shell portion at any location.

In yet another embodiment, a food product comprises a lobster tail having a shell portion disposed generally on dorsal and lateral sides of the lobster tail, and a meat portion disposed generally adjacent to the shell portion. The lobster tail includes a membrane disposed generally at a location where a swimmeret has been at least partially separated from the lobster tail. A skewer extends through the membrane and into the meat portion. However the skewer does not run through the shell portion at any location.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIGS. 1A and 1B are perspective views of lobster tails and skewers;

FIGS. 2A and 2B are views of a dorsal side and a ventral side, respectively, of a lobster tail;

FIG. 3 is a perspective view of a lobster tail after the sternite has been cut or split in accordance with an embodiment of the invention;

FIG. 4 is a perspective view of the lobster tail of FIG. 3 with the meat portion separated from the hard shell portion;

FIG. 5 is a perspective view of the lobster tail of FIG. 3 with a skewer extending through the lobster tail in accordance with an embodiment of the invention; and

FIG. 6 is a perspective view of a lobster tail and skewer in accordance with another embodiment of the invention.

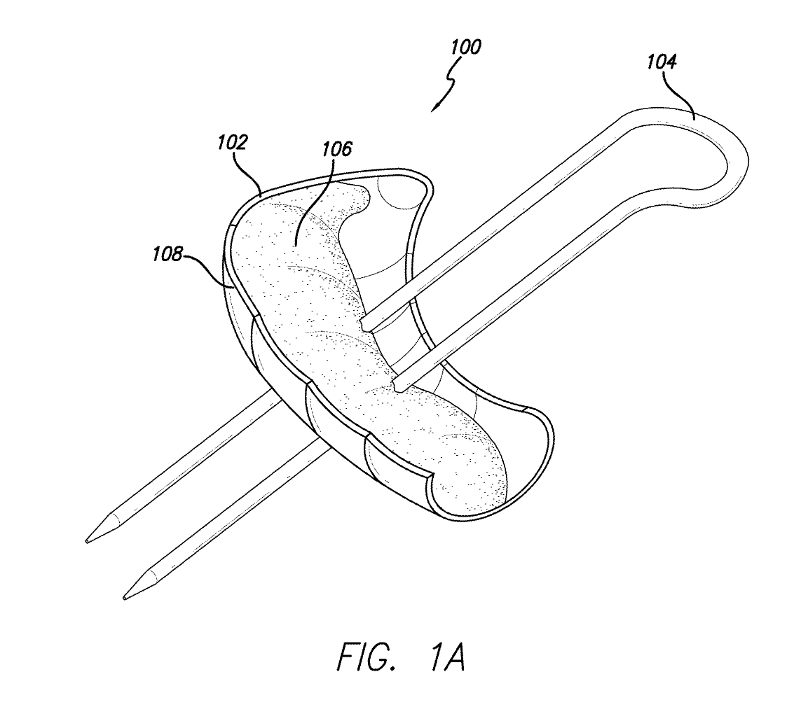

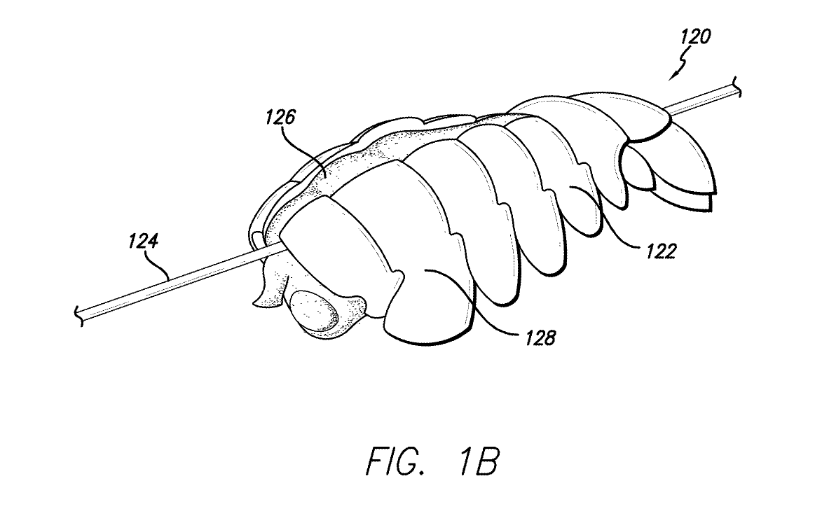

### DETAILED DESCRIPTION

The following description is of the best mode presently contemplated for carrying out the invention. Disclosed are novel seafood products as well as methods for their preparation. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

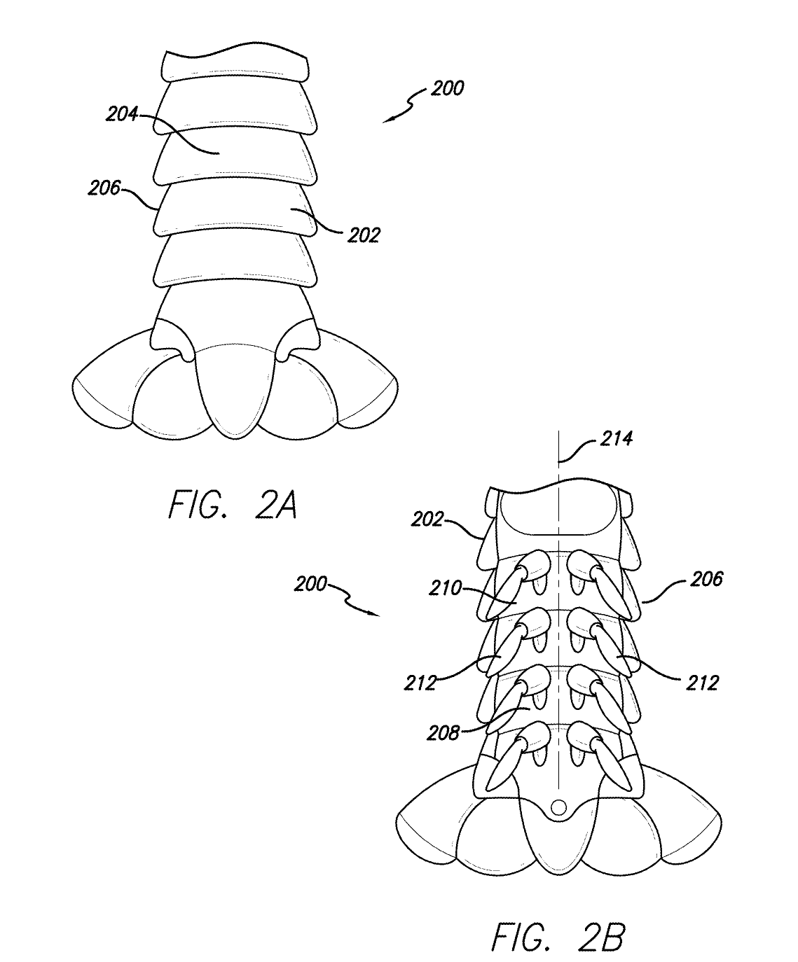

FIG. 2A is dorsal (or top) view of a lobster tail 200. The lobster tail 200 includes a hard shell portion 202 disposed generally on a dorsal side 204 and a lateral side 206 of the lobster tail 200. FIG. 2B is a ventral (or bottom) view of the lobster tail 200 of FIG. 2A. A sternite 208 (sometimes referred to as a sternum) is a relatively soft shell or membrane portion of the lobster tail 200 and is disposed generally on a ventral side 210 of the lobster tail 200 so that the sternite 208 covers an abdomen muscle (not shown in FIG. 2A) which is the edible or meat portion of the lobster tail 200. A plurality of swimmerets 212 extends from the ventral side 210. As previously mentioned the hard shell portion 202 is disposed generally on the lateral side 206 (as well as the dorsal side 204 shown in FIG. 2A). An imaginary line 214 is shown as a broken line in FIG. 2B and runs generally longitudinally along the sternite 208 down the length of the lobster tail 200 and is disposed approximately on the center of the sternite 208.

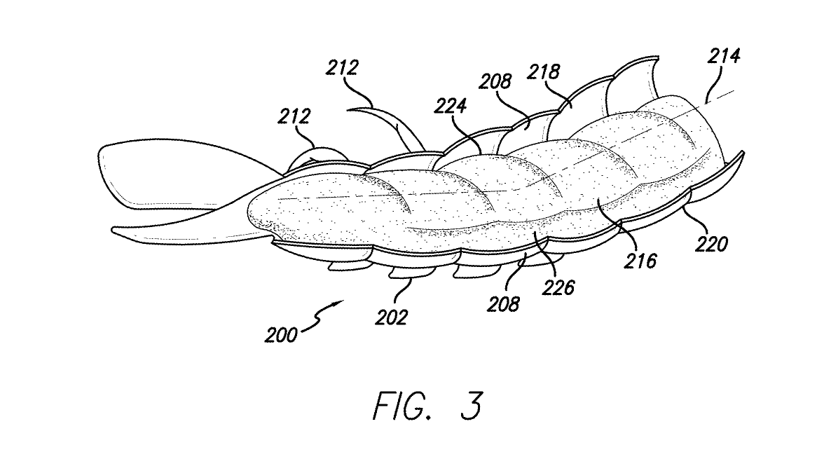

According to an embodiment of the invention the sternite 208 is cut along the imaginary line 214 using a band saw, a knife or other cutting instrument. This will result in the splitting of the sternite 208 and the exposing of a meat portion 216 of the lobster tail 200 as shown in FIG. 3. After it has been cut, the sternite 208 is transformed into a proximate sternite portion 218 and a distal sternite portion 220 with the meat portion 216 disposed between the proximate and distal sternite portions 218, 220. Still referring to FIG. 3, the proximate sternite portion 218 extends down the longitudinal length of one side of the lobster tail 200 and is disposed adjacent to a proximate meat lateral side 224 of the meat portion 216 on one side of the imaginary line 214. Similarly the distal sternite portion 220 extends down the longitudinal length of the other side of the lobster tail 200 and is disposed adjacent to a distal meat lateral side 226 of the meat portion 216 on another side of the imaginary line 214.

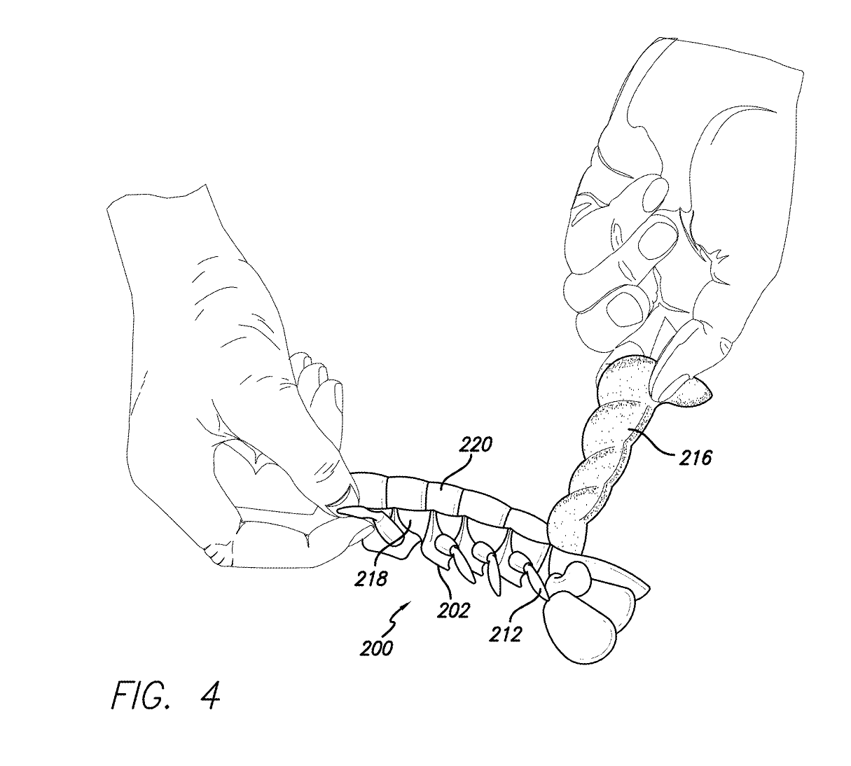

Referring now to FIG. 4, one end (the forward end) of the meat portion 216 is grasped and pulled away from the shell portion 202 of the lobster tail 200 so that at least most, but not necessarily all, of the meat portion 216 is separated from the shell portion 202. Next the part of the meat portion 216 that was separated is placed onto or returned back to the shell portion 202. This separation of the meat portion 216 from the shell portion 202 is believed to facilitate the eating of the lobster tail 200 after cooking in that the cooked meat portion 216 should be easier for a person to remove from the shell portion 202 just prior to eating. In alternative embodiments however the meat portion 216 is not separated from the shell portion 202.

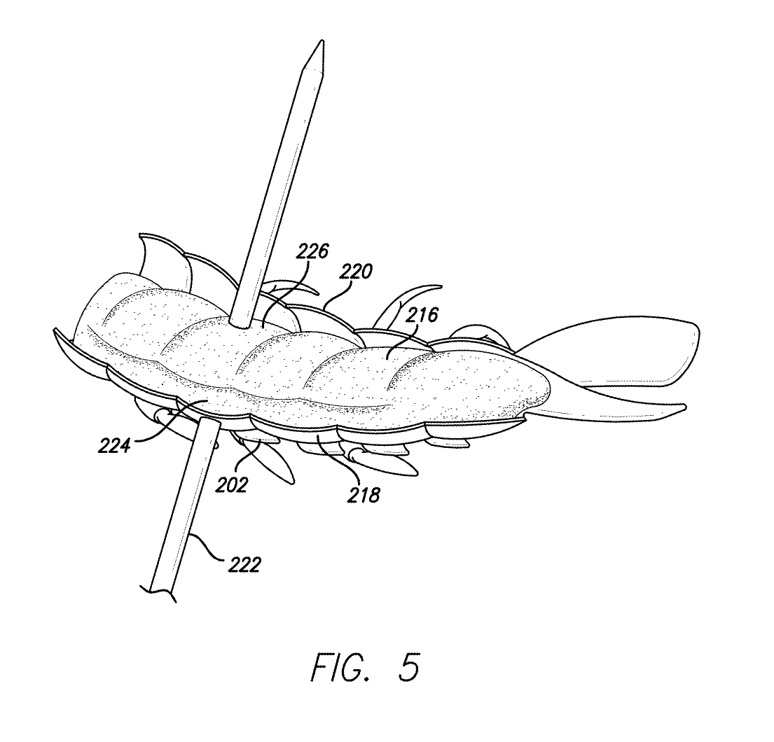

Referring now to FIG. 5, a skewer 222 constructed of wood is pushed in a generally lateral direction so that it pierces the proximate sternite portion 218, travels through it and into the proximate meat lateral side 224. The skewer 222 travels further through the meat portion 216 and exits from the distal meat lateral side 226 at a location that is generally adjacent to the distal sternite portion 220. However the skewer 222 exits the distal meat lateral side 226 at a slightly upward angle so that the skewer 222 does not pierce or run through the distal sternite portion 220, nor does it pierce or run through the shell portion 202 at any location.

While the skewer 222 does not pierce or run through the distal sternite portion 220 in the illustrated embodiment, alternate embodiments include the skewer 222 extending through the distal sternite portion 222, the meat portion 216 and the proximate sternite portion 218 while not running through the shell portion 202 at any location of the shell portion 202.

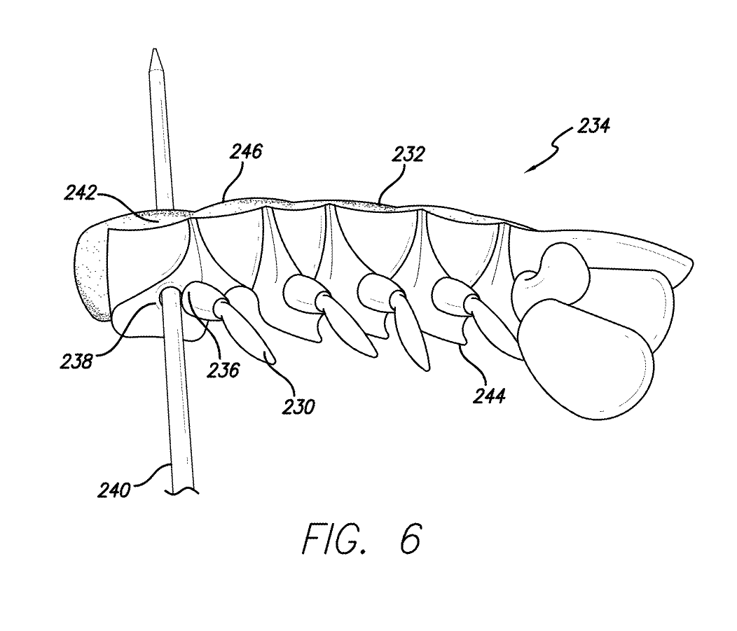

In the embodiment of FIG. 5 a hole is created in the proximate sternite portion 218 by the pushing of the skewer 222 through it. FIG. 6 illustrates an alternative embodiment that includes a hole that is created by the insertion of a skewer at a different location. Referring to FIG. 6 a swimmeret 230 is pulled in a direction generally away from a meat portion 232 of a lobster tail 234 having a shell portion 244. The swimmeret 230 is pulled with enough force to at least partially separate it from the lobster tail 234 at a coxa joint 236 thereby exposing a membrane 238 located generally at the former location of the coxa joint 236. A skewer 240 is then pushed in a generally lateral direction through the membrane 238 and into a proximate meat lateral side 242 of the meat portion 232. The remaining steps and seafood product are generally the same as described above in connection with FIGS. 3-5. Again however the skewer 240 does not pierce the shell portion 244 at any location.

In the embodiment of FIG. 6 the skewer 240 exits the meat portion 232 on a distal meat lateral side 246 at a location that is generally adjacent to a distal sternite portion (not shown in FIG. 6) without running through any other membrane or through any sternite portion. In an alternative embodiment however the skewer 240 exits from the distal meat lateral side 246 and pierces the distal sternite portion (thus extending through it) located on generally the opposite side of the meat portion 232 as the membrane 238.

In yet another alternative embodiment to that of FIG. 6, a second swimmeret (disposed on generally the opposite side of the lobster tail 234 as the first swimmeret 230) is pulled in a generally similar fashion as described above. This exposes a second membrane located generally at the former location of a second coax joint and located on the opposite side of the lobster tail as the first membrane 238. In this embodiment the skewer 240 exits from the distal meat lateral side 244 and is pushed through the second membrane. Again however the skewer 240 does not run through the shell portion 244 at any location.

It will further be appreciated that any of the above-described methods and food products can be used so that one or a plurality of skewers can be inserted through one or a plurality of lobster tails thereby sometimes providing convenience of cooking, enhanced food handling, or variations in aesthetically-pleasing food presentation.

In view of the above, it will be appreciated that certain embodiments of the invention overcome many of the long-standing problems in the art by providing a food product comprising a lobster tail having a sternite, a shell portion, and a meat portion. The sternite is split or cut along the length of the lobster tail thereby exposing the meat portion. A wood skewer extends through a proximate sternite portion and into the meat portion so that the skewer exits from the meat portion on or near the opposite meat lateral side at a location that is generally adjacent to a distal sternite portion without running through the distal sternite portion and without running through the shell portion.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A method of processing a lobster tail having a shell portion disposed generally on dorsal and lateral sides of the lobster tail, a sternite disposed generally on a ventral side of the lobster tail, and a meat portion disposed generally adjacent to the shell portion and the sternite, the method comprising:
cutting the sternite along an imaginary line generally running the length of the lobster tail thereby splitting at least a portion of the sternite and exposing the meat portion, wherein after the cutting of the sternite, the sternite is comprised of a proximate sternite portion disposed on one side of the imaginary line and a distal sternite portion disposed on another side of the imaginary line; and
pushing a skewer through the proximate sternite portion and into the meat portion, so that the skewer does not run through the shell portion.

2. The method of claim 1 further comprising:
pulling at least a portion of the meat portion away from the shell portion after the cutting of the sternite and prior to the pushing of the skewer; and
placing the at least the portion of the meat portion onto the shell portion after the pulling of the at least the portion of the meat portion.

3. The method of claim 1 wherein pushing the skewer includes pushing the skewer so that the skewer exits from the meat portion at a location that is generally adjacent to the distal sternite portion without running through the shell portion.

4. The method of claim 1 wherein the meat portion has a proximate meat lateral side and a distal meat lateral side, wherein pushing the skewer includes pushing the skewer so that the skewer enters the meat portion on the proximate meat lateral side and exits from the meat portion on the distal meat lateral side and extends through the distal sternite portion, so that the skewer does not run through the shell portion.

5. The method of claim 1 wherein the skewer is a first skewer, the method further comprising:
pushing a second skewer through the proximate sternite portion and into the meat portion, so that the second skewer does not run through the shell portion.

6. A method of processing a lobster tail having a shell portion disposed generally on dorsal and lateral sides of the lobster tail, a sternite disposed generally on a ventral side of the lobster tail, and a meat portion disposed generally adjacent to the shell portion, the method comprising:
cutting the sternite along an imaginary line generally running the length of the lobster tail thereby splitting at least a portion of the sternite and exposing the meat portion, wherein after the cutting of the sternite, the sternite is comprised of a proximate sternite portion disposed on one side of the imaginary line and a distal sternite portion disposed on another side of the imaginary line;
pulling at least a portion of the meat portion away from the shell portion after the cutting of the sternite;
placing the at least the portion of the meat portion onto the shell portion after the pulling of the at least the portion of the meat portion; and
pushing a skewer through the proximate sternite portion and into the meat portion, so that the skewer exits from the meat portion at a location that is generally adjacent to the distal sternite portion and so that the skewer does not run through the shell portion.

7. A method of processing a lobster tail having a swimmeret, a shell portion disposed generally on dorsal and lateral sides of the lobster tail, and a meat portion disposed generally adjacent to the shell portion, the method comprising:
pulling the swimmeret in a direction generally away from the meat portion thereby at least partially separating the swimmeret from the lobster tail at a coxa joint and thereby exposing a membrane; and
pushing a skewer through the membrane and into the meat portion, so that the skewer does not run through the shell portion.

8. The method of claim 7 further comprising:
pulling at least a portion of the meat portion away from the shell portion prior to the pushing of the skewer; and
placing the at least the portion of the meat portion onto the shell portion after the pulling of the at least the portion of the meat portion.

9. The method of claim 7 wherein the lobster tail further has a sternite disposed generally on a ventral side of the lobster tail, the method further comprising:
cutting the sternite along an imaginary line generally running the length of the lobster tail thereby splitting at least a portion of the sternite and exposing the meat portion,
wherein after the cutting of the sternite, the sternite is comprised of a proximate sternite portion disposed on one side of the imaginary line and a distal sternite portion disposed on the other side of the imaginary line, and
wherein pushing the skewer includes pushing the skewer so that the skewer exits from the meat portion at a location that is generally adjacent to the distal sternite portion without running through the shell portion.

10. The method of claim 7 wherein the lobster tail further has a sternite disposed generally on a ventral side of the lobster tail, and wherein the meat portion has a proximate meat lateral side and a distal meat lateral side, the method further comprising:
cutting the sternite along an imaginary line generally running the length of the lobster tail thereby splitting at least a portion of the sternite and exposing the meat portion,
wherein after the cutting of the sternite, the sternite is comprised of a proximate sternite portion disposed on one side of the imaginary line and a distal sternite portion disposed on the other side of the imaginary line, and
wherein pushing the skewer includes pushing the skewer so that the skewer enters into the meat portion on the proximate meat lateral side and exits from the meat portion on the distal meat lateral side and extends through the distal sternite portion, so that the skewer does not run through the shell portion.

11. The method of claim 7 wherein the swimmeret is a first swimmeret, the coxa joint is a first coxa joint, and the membrane is a first membrane, the method further comprising:
pulling a second swimmeret in a direction generally away from the meat portion thereby at least partially separating the second swimmeret from the lobster tail at a second coxa joint and thereby exposing a second membrane,
wherein the second swimmeret and the second membrane are disposed on generally the opposite side of the lobster tail as the first swimmeret and the first membrane; and
pushing the skewer through the second membrane so that the skewer does not run through the shell portion, wherein the pushing of the skewer through the second membrane is after the pushing of the skewer through the first membrane and into the meat portion.

12. The method of claim 7 wherein the skewer is a first skewer, the swimmeret is a first swimmeret, the membrane is a first membrane, and the coxa joint is a first coxa joint, the method further comprising:
pulling a second swimmeret in a direction generally away from the meat portion thereby at least partially separating the second swimmeret from the lobster tail at a second coxa joint and thereby exposing a second membrane; and
pushing a second skewer through the second membrane and into the meat portion so that the second skewer does not run through the shell portion.

13. A food product comprising:
a lobster tail having a sternite, a shell portion disposed generally on dorsal and lateral sides of the lobster tail, and a meat portion disposed generally adjacent to the shell portion and the sternite, wherein at least a portion of the sternite is split along an imaginary line generally running the length of the lobster tail thereby exposing the meat portion and thereby forming a proximate sternite portion disposed on one side of the imaginary line and a distal sternite portion disposed on the other side of the imaginary line; and
a skewer extending through the proximate sternite portion and into the meat portion,
wherein the skewer does not run through the shell portion.

14. The food product of claim 13 wherein at least a portion of the meat portion is not attached to the shell portion while disposed on the shell portion.

15. The food product of claim 13 wherein the skewer further extends through the meat portion so that the skewer exits from the meat portion at a location that is generally adjacent to the distal sternite portion without running through the shell portion.

16. The food product of claim 13 wherein the meat portion has a proximate meat lateral side and a distal meat lateral side, wherein the skewer extends into the proximate meat lateral side and exits from the meat portion on the distal meat lateral side and wherein the skewer further extends through the distal sternite portion, so that the skewer does not extend through the shell portion.

17. The food product of claim 13 wherein the skewer is a first skewer, the food product further comprising:
a second skewer extending through the proximate sternite portion and into the meat portion, so that the second skewer does not run through the shell portion.

18. The food product of claim 13 wherein the skewer is constructed of a wood material.

19. A food product comprising:
a lobster tail having a sternite, a shell portion disposed generally on dorsal and lateral sides of the lobster tail, and a meat portion disposed generally adjacent to the shell portion and the sternite,
wherein at least a portion of the sternite is split along an imaginary line generally running the length of the lobster tail thereby exposing the meat portion and thereby forming a proximate sternite portion disposed on one side of the imaginary line and a distal sternite portion disposed on the other side of the imaginary line, and
wherein at least a portion of the meat portion is not attached to the shell portion; and
a skewer extending through the proximate sternite portion and through the meat portion so that the skewer exits from the meat portion at a location that is generally adjacent to the distal sternite portion, wherein the skewer does not run through the shell portion.

20. A food product comprising:
a lobster tail having a shell portion disposed generally on dorsal and lateral sides of the lobster tail, and a meat portion disposed generally adjacent to the shell portion, and wherein the lobster tail includes a membrane disposed generally at a location where a swimmeret has been at least partially separated from the lobster tail; and
a skewer extending through the membrane and into the meat portion,
wherein the skewer does not run through the shell portion.

21. The food product of claim 20 wherein at least a portion of the meat portion is not attached to the shell portion while disposed on the shell portion.

22. The food product of claim 20 wherein the lobster tail further has a sternite disposed generally on a ventral side of the lobster tail,
wherein at least a portion of the sternite is split along an imaginary line generally running the length of the lobster tail thereby exposing the meat portion and thereby forming a proximate sternite portion disposed on one side of the imaginary line and a distal sternite portion disposed on the other side of the imaginary line, and
wherein the skewer further extends through the meat portion so that the skewer exits through the meat portion at a location that is generally adjacent to the distal sternite portion without running through the shell portion.

23. The food product of claim 20 wherein the lobster tail further has a sternite disposed generally on a ventral side of the lobster tail,
wherein at least a portion of the sternite is split along an imaginary line generally running the length of the lobster tail thereby exposing the meat portion and thereby forming a proximate sternite portion disposed on one side of the imaginary line and a distal sternite portion disposed on the other side of the imaginary line,
wherein the meat portion has a proximate meat lateral side and a distal meat lateral side, and
wherein the skewer further extends through the meat portion so that the skewer exits from the meat portion on the distal meat lateral side and extends through the distal sternite portion and so that the skewer does not extend through the shell portion.

24. The food product of claim 20, wherein the swimmeret is a first swimmeret and wherein the membrane is a first membrane,
wherein the lobster tail includes a second membrane disposed generally at a location where a second swimmeret has been at least partially separated from the lobster tail, and wherein the second membrane is further disposed on generally the opposite side of the lobster tail as the first membrane, and
wherein the skewer further extends through the second membrane and wherein the skewer does not run through the shell portion.

25. The food product of claim 20 wherein the skewer is a first skewer, wherein the swimmeret is a first swimmeret, wherein the membrane is a first membrane, and wherein the lobster tail includes a second membrane disposed generally at a location where a second swimmeret has been at least partially separated from the lobster tail, the food product further comprising:
a second skewer extending through the second membrane and extending into the meat portion,
wherein the second skewer does not run through the shell portion.
